(19) United States
(12) Patent Application Publication
(10) Pub. No.: US 2017/0320415 A1
(43) Pub. Date: Nov. 9, 2017

(54) Lightweight Seat for Vehicles

(71) Applicant: Bayerische Motoren Werke Aktiengesellschaft, Muenchen (DE)

(72) Inventors: Andreas MUELLER, Bruckberg (DE); Marcus SEDLMAIER, Woerth/Isar (DE)

(21) Appl. No.: 15/660,341

(22) Filed: Jul. 26, 2017

Related U.S. Application Data
(63) Continuation of application No. PCT/EP2016/050652, filed on Jan. 14, 2016.

(30) Foreign Application Priority Data
Jan. 26, 2015 (DE) 10 2015 201 237.9

(51) Int. Cl. B60N 2/64; A47C 7/02; A47C 7/18; B60N 2/68

(52) U.S. Cl. CPC B60N 2/646; B60N 2/686; A47C 7/022; A47C 7/185

(57) ABSTRACT

A lightweight seat for vehicles, in particular for rear seats of motor vehicles, has a carrier part, wherein the carrier part is produced from a dimensionally stable material and integrally includes at least one seat shell for a seat user.

### CROSS REFERENCE TO RELATED APPLICATIONS

This application is a continuation of PCT International Application No. PCT/EP2016/050652, filed Jan. 14, 2016, which claims priority under 35 U.S.C. §119 from German Patent Application No. 10 2015 201 237.9, filed Jan. 26, 2015, the entire disclosures of which are herein expressly incorporated by reference.

### BACKGROUND AND SUMMARY OF THE INVENTION

The invention relates to a lightweight seat for vehicles. The invention relates particularly to a rear seat for motor vehicles having a dimensionally stable, preferably one-piece seat part with a soft foam pad.

Vehicle seats, like other components and fittings in vehicles, are increasingly subject to weight reduction with the simultaneous need to maintain functionality and comfort. An exemplary vehicle seat is known from patent application DE 198 45 730 A1. The cushion part of this seat is formed as a backrest which has a sandwich structure made up of a molded foam part, a soft cushion and a shaped shell of lightweight metal situated therebetween. The molded foam part is covered on the rear side by a rear wall element. Such a cushion part is suitable in principle for reducing the weight of the vehicle when compared against seats with conventional steel structures. However, the chosen design is suitable only for use in backrests and is moreover still relatively heavy on account of the shaped metal shell used.

DE 10 354 065 B4 discloses a vehicle seat, in particular for a motor vehicle, which is produced from a cushion part having a hard foam part and a soft foam pad. Here, the cushion part of the vehicle seat is formed as a seat part, the hard foam part having a surface which is formed congruently to the vehicle floor at least in certain regions and which can be brought into positive engagement with the vehicle floor in the use position of the seat part. The seat part is able to be released from its positive engagement by way of an articulated mechanism and moved into a non-use position. Such a design makes it possible to dispense with a solid articulated mechanism for the seat part that dissipates the weight of the vehicle occupant into the vehicle structure, particularly in the event of a crash. Instead, the forces are transferred directly from the hard foam part into the vehicle floor by virtue of the positive engagement. The result is that the articulated mechanism serves only to guide the movement of the seat part. It is therefore possible for the articulated mechanism to be anchored directly in the hard foam part, that is to say without the need for a metal supporting structure arranged in the seat part.

Furthermore, DE 102010024207 A1 discloses a backrest part or seat part for a vehicle seat or a vehicle seat bench, and a method for producing same. The supporting structure has at least one frame element consisting of a fiber-reinforced polypropylene (PP) or a fiber-reinforced polyurethane (PUR) and at least one surface element consisting, inter alia, of expanded polypropylene foam (EPP).

Moreover, DE 102012200441 A1 discloses a mounting arrangement for a vehicle seat frame and a production method. The vehicle seat arrangement includes a seat frame which consists of structural foam (expanded polyolefin).

However, in the case of the seats known in the prior art, it is disadvantageous that, for the various functions (such as, for example, seating function, retaining function, anchoring of the pads, intrinsic stability and the like), in each case specific construction parts or arrangements provided specifically therefor are used in the assembly, such as, for example, seat frames, frame elements, articulated mechanisms, connecting elements for seat pads, foam pads and the like. Since each of these functional parts also has an intrinsic weight, such seats are thus still relatively heavy.

Accordingly, the object on which the invention is based is to overcome the aforesaid disadvantages and to provide a vehicle seat of which the weight is further reduced, which is simple to produce and which has a large number of basic functions.

This and other objects are achieved by a lightweight seat for vehicles, in particular for rear seats for motor vehicles, comprising a carrier part, wherein the carrier part is produced from a dimensionally stable material and integrally comprises at least one seat shell for a seat user.

The basic idea of the present invention is to produce, preferably in one piece, a specific shape from a specific dimensionally stable material, with the result that a plurality of functions are integrated in the seat part according to the invention.

The achievement of the object on which the invention is based comprises, in the first instance, presenting a rear seat which is optimized in terms of lightweight design and which consists mainly, i.e. virtually completely, of an EPP foam. The seat preferably is made of expanded polypropylene particle foam (EPP) from which complex three-dimensional molded parts of low weight can be produced cost-effectively. Besides the supporting function of the chosen material, it is thereby also possible at the same time to form the seat shell, i.e. the desired seat contour, in one operation and in a final seat shape. This design is distinguished from the known seats in that, instead of a conventional PUR soft foam, use is made of a dimensionally stable foam.

If the dimensionally stable foam used is an EPP foam, the foam can therefore also assume the complete supporting function of the seat bench. It is thus also possible for forces typically occurring during driving to be channeled directly, for example non-positively, into the seat. Due to the dimensional stability of EPP foam, in comparison with material combinations of PUR foam, EPP foam and other structural elements, the other structural elements such as those of a wire frame, can be completely dispensed with, which results in a significant weight reduction.

A further aspect of the present invention concerns the fact that the seat contours are already preformed in the EPP carrier part or integrated in the carrier part and are optimally tailored to the human anatomy and thus perform a key comfort function.

Moreover, there is provision according to the invention to fit the EPP carrier part with a very thin cushion pad, preferably of constant material thickness, as an additional comfort element which can be produced without a mold, for example. Thus, for example, meter product consisting of cut foam, knitted fabrics, cotton wool or the like can be used, which is accompanied not only by the weight advantages but also by time and cost advantages in production. Therefore, there is no need for a separate mold with a specific mold shape to produce the cushion pad. In addition to the weight advantages and cost advantages, mention should also be made of the more compact design.

According to the invention, there is therefore proposed a lightweight seat for vehicles, in particular for rear seats for motor vehicles, comprising a carrier part, wherein the carrier part is produced from a dimensionally stable material and integrally comprises at least one seat shell for a seat user. Two seat shells are preferably provided for a rear seat.

In a preferred embodiment of the invention, it is provided that the dimensionally stable material consists virtually to completely of an expanded polypropylene particle foam (EPP). It is thus possible for the entire seat (with the exception of an optional seat pad) to be produced with a single mold.

Accordingly, it is further preferred if the carrier part substantially forms the entire lightweight seat. Mounting advantages are thus also obtained since an assembly of individual seat parts is not required.

In a further advantageous refinement of the invention, the at least one seat shell is formed as a depression which corresponds to the shape of the buttocks. In other words, the seat shell shape is already formed as intended in the mold such that the surface is ergonomically tailored to the buttocks of a seat user.

It is particularly advantageous if the seat is delimited by a front side and a rear side (to be precise as viewed in the installed state in the longitudinal direction of the vehicle) and the depression has a rear seat shell portion which rises toward the rear side, i.e. rearwardly, and which forms a part of the seat shell shape.

It is further advantageous if the rear seat shell portion is adjoined by two seat shell portions which extend in the direction of the front side and which rise in a transverse direction toward the respective edge of the seat shell. Such a design provides an ergonomic depression to allow a seat user to be comfortably seated. The above-described seat shell portions form overall the bearing surface for applying a thin foam cushion.

In a development of the present invention, provision can therefore be made for the carrier part to preferably have a plurality of retaining devices to provide a soft foam pad with a toolless fastening possibility. It is also of advantage here that provision is made for the retaining devices to be formed in one piece with the carrier part, for example the EPP carrier part, preferably in the region of the seat shell(s). The fastening mechanism is thus likewise integrated into the seat part. In other words, a plug-in solution, for example, is provided which is produced by the formation of channels and/or hooks. Matching strips as counterpart retaining elements are then mounted on the seat cover. Thus, for example, a cushion pad with suitable retaining elements can be toollessly fastened directly to the carrier part, i.e. to the integrated retaining devices.

In a preferred embodiment of the invention, there is further provision that a thin cushion pad with a uniform material thickness in the thickness direction is to be respectively provided on each seat shell of the carrier part. The cushion pad is preferably adapted to correspond to the contour of the seat shell and further preferably arranged above the seat shell regions.

In an inventive development of the invention, there is further provision that at least one armrest is formed by the carrier part adjacently to at least one seat shell. It is thus also possible for a respective armrest to be formed in each case adjacently to each seat shell on the right and on the left.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 illustrates a perspective view of an exemplary embodiment of a lightweight seat according to the invention with two cushion pads in an exposed, i.e. non-connected, position thereabove.

### DETAILED DESCRIPTION OF THE DRAWING

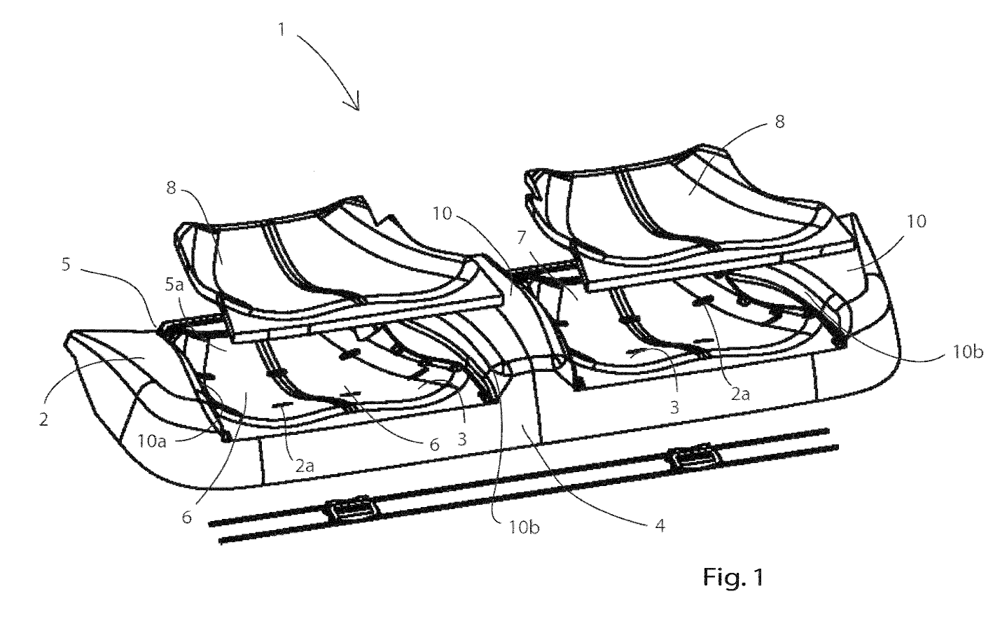

FIG. 1 shows an exemplary embodiment of a seat 1, to be precise a lightweight seat 1 for vehicles. The seat illustrated constitutes a rear seat for a motor vehicle including a carrier part 2. The carrier part 2 is produced from a dimensionally stable material. For the purposes of the present invention, the term “dimensionally stable” pertains to a foam which cannot be compressed like a soft foam, but rather withstands the weight of a seat user without noticeably deforming. The dimensionally stable material used here consists completely of an expanded polypropylene particle foam (EPP). It can further be seen that the carrier part 2 substantially forms the entire lightweight seat 1 (with the exception of the two cushion pads 8).

The carrier part 2 has two seat shells 3 for a respective seat user. The seat shells 3 can be divided substantially into three seat shell portions 5a, 6. The cushion pads 8 are applied to the seat shell portions 5a, 6 in the mounted state (not shown).

It can further be seen that each seat shell 3 is formed in the carrier part 2 as a depression which corresponds to the shape of the buttocks. The seat is delimited by a front side 4 and a rear side 5 when viewed in the longitudinal direction of the vehicle. The depressions forming the seat shell 3 have the rear seat shell portion 5a which rises rearwardly toward the rear side 5. Furthermore, the rear seat shell portion 5a is adjoined by two seat shell portions 6 which extend in the direction of the front side 4. They extend approximately parallel and are designed to receive the upper part of the thigh. The two seat shell portions 6 rise in a transverse direction (i.e. when viewed parallel to the front side 4 and to the rear side 5) toward the respective edge 7 of the seat shell 3, resulting in an approximately concave or bi-concave seat shell shape.

The carrier part 2 is further equipped with retaining devices 2a for toollessly fastening the soft foam pads 8. The retaining devices 2a are formed in one piece with the carrier part 2 in the region of the seat shells 3. A thin cushion pad 8 with a uniform material thickness in the thickness direction is respectively fastened on each seat shell 3 of the carrier part 2 by way of the retaining devices 2a (at corresponding fixing points).

The seat shells 3 each have an armrest 10 on the right and on the left. The armrests likewise are formed in one piece with the carrier part 2. The armrests 10 simultaneously laterally delimit the seat shell region by way of side walls 10a, 10b and thus provide the seat user with a side hold.

The invention is not limited in its execution to the above-indicated preferred exemplary embodiments. On the contrary, a number of variants are conceivable which make use of the illustrated solution, even in embodiments of fundamentally different type. Thus, besides the rear seat bench as such, it is also possible, for example, for a seat back to be formed in accordance with the teaching of the present invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A lightweight seat for a vehicle, comprising:
a carrier part formed of a dimensionally stable material, wherein
the carrier part integrally comprises at least one seat shell for a seat user.

2. The lightweight seat as claimed in claim 1, wherein the lightweight seat is a rear seat for a motor vehicle.

3. The light seat as claims in claim 1, wherein the dimensionally stable material consists completely of an expanded polypropylene particle foam.

4. The lightweight seat as claimed in claim 3, wherein the carrier part substantially forms the entire lightweight seat.

5. The lightweight seat as claimed in claim 1, wherein the carrier part substantially forms the entire lightweight seat.

6. The lightweight seat as claimed in claim 1, wherein the at least one seat shell is formed in the carrier part as a depression corresponding to a shape of human buttocks.

7. The lightweight seat as claimed in claim 3, wherein the at least one seat shell is formed in the carrier part as a depression corresponding to a shape of human buttocks.

8. The lightweight seat as claimed in claim 6, wherein
the seat is delimited by a front side and a rear side as viewed in a longitudinal direction of the vehicle, and
the depression has a rear seat shell portion rising rearwardly toward the rear side.

9. The lightweight seat as claimed in claim 8, wherein the rear seat shell portion is adjoined by two seat shell portions which extend in the direction of the front side and which rise in a transverse direction toward a respective edge of the seat shell.

10. The lightweight seat as claimed in claim 9, wherein the carrier part has retaining devices for toollessly fastening a soft foam pad.

11. The lightweight seat as claimed in claim 1, wherein the carrier part has retaining devices for toollessly fastening a soft foam pad.

12. The lightweight seat as claimed in claim 10, wherein the retaining devices are formed in one piece with the carrier part.

13. The lightweight seat as claimed in claim 12, wherein the retaining devices are formed in a region of the seat shells.

14. The lightweight seat as claimed in claim 1, further comprising:
a thin cushion pad with a uniform material thickness in a thickness direction respectively fastened on each seat shell of the carrier part.

15. The lightweight seat as claimed in claim 1, wherein at least one armrest is formed by the carrier part adjacently to the at least one seat shell.

16. The lightweight seat as claimed in claim 1, wherein the carrier part integrally comprises two seat shells for two seat users.

17. The lightweight seat as claimed in claim 16, wherein the dimensionally stable material consists completely of an expanded polypropylene particle foam.

18. The lightweight seat as claimed in claim 17, wherein
the two seat shells are formed as depressions corresponding to a human buttocks shape and,
each depression has a rear seat shell portion rising rearwardly toward a rear side of the seat, and the rear seat shell portion is adjoined by two seat shell portions extending in a direction of a front side of the seat and which rise in a transverse direction toward a respective edge of the seat shell.

19. The lightweight seat as claimed in claim 18, wherein retaining devices are formed in one piece with the carrier part.

20. The lightweight seat as claimed in claim 19, wherein at least one arm rest is formed by the carrier part adjacently to each of the two seat shells.
